(19) United States
(12) Patent Application Publication
(10) Pub. No.: US 2009/0091310 A1
(43) Pub. Date: Apr. 9, 2009

(54) Apparatus and Methods for Powering Remote Devices Under Dynamic Source and Load Conditions

(75) Inventors: David Levenson, Duluth, GA (US); John A. Autry, Colleyville, TX (US)

Correspondence Address: AT&T Legal Department - MB;Attn: Patent Docketing, Room 2A-207, One AT&T Way, Bedminster, NJ, 07921, US

(73) Assignee: AT&T BLS Intellectual Property, Inc.

(21) Appl. No.: 11/866,605

(22) Filed: Oct. 3, 2007

(51) Int. Cl. G05F 5/00

(52) U.S. Cl. 323/299

(57) ABSTRACT

Power provided to a remote network component is regulated. A monitoring circuit estimates a DC input voltage that is received from a central network supply. A control circuit compares the DC input voltage to a threshold DC voltage value to determine if the DC input voltage exceeds the threshold DC voltage value. A voltage conversion circuit converts the DC input voltage to a DC output voltage that is provided at an output voltage conductor and that is less than the threshold DC voltage value, if the DC input voltage exceeds the threshold DC voltage value. A bypass circuit bypass the voltage conversion circuit and transmit the DC input voltage to the output voltage conductor as the DC output voltage if the DC input voltage is less than the threshold DC voltage value.

### FIELD OF THE APPLICATION

This disclosure relates to electrical apparatus and methods and, more particularly, to apparatus and methods for providing power to remote devices.

### BACKGROUND

Providing electrical power to remotely located devices from a central power supply has become increasingly beneficial in a variety of paradigms. For example, in a communication system, such as, for example, a communication network, remotely located network devices may be powered from a centrally located power source. For example, in the case of a conventional broadband communications system, as illustrated in FIG. 1, a system network interface 10 may provide network services to multiple network interface units 12A and 12B located at different subscriber premises 16A and 16B containing, e.g., apartment units 14, via any of a variety of data communication media 24. Exemplary network services may include those provided by a video provider 32, an Internet provider 34, and/or a telephone provider 36, among others.

Remotely located network interface units 12A and 12B may be powered from a centrally located system power source 20. For example, power may be provided as a direct current (DC) supply voltage provided at the system power source 20 and transmitted via power conductors 30 to the various network interface units 12A and 12B. Distances from different network interface units 12A and 12B to the system power source 20 may vary greatly. In this regard, the power conductors 30 utilized to transmit power to the different network interface units 12A and 12B may exhibit a corresponding variety of resistance values. Additionally, load requirements corresponding to each of the subscriber premises 16A and 16B are dynamic and may vary based on a variety of factors including, for example, quantity and types of services provided by the network interface units 12A and 12B and the instantaneous state of subscriber lines.

As a result of the dynamic load and variety of power conductor 30 lengths, a network interface unit 12A and 12B deployed at a maximum design distance from a system power source 20 may have an input voltage as low as one half of the source voltage provided at the system power source 20 when the network interface unit 12A and 12B is consuming maximum power. Thus, to reduce undesirable results associated with low voltage at distant network interface units 12A and 12B, the source voltage of the system power source 20 may be increased significantly. However, since a network interface unit 12A and 12B in a minimal power state may have an input voltage very close to the source voltage provided at the system power source 20, maximum permitted voltages according to, for example, installation requirements, network equipment specifications and/or guidelines issued by regulatory agencies, may be exceeded.

### SUMMARY

Exemplary embodiments provide methods for providing power to remote devices. According to some embodiments, methods include receiving a DC input voltage and comparing the DC input voltage to a threshold DC voltage value to determine if the received DC input voltage exceeds the threshold DC voltage value. Such methods may further include converting, if the DC input voltage exceeds the threshold DC voltage value, the DC input voltage into a DC output voltage that is below the threshold DC voltage value and transmitting, if the DC input voltage is less than the threshold DC voltage value, the DC input voltage to the remote network device as the DC output voltage.

Some embodiments may include transitioning from converting the DC input voltage to transmitting the DC input voltage and from transmitting the DC input voltage to converting the DC input voltage. In some embodiments, transitioning includes filtering the DC output voltage to dampen a transition from the converting the DC input voltage to the transmitting the received voltage. In some embodiments, filtering includes providing capacitance at an output terminal corresponding to the DC output voltage.

Some embodiments include determining the threshold DC voltage value based on a regulatory agency installation code requirement and receiving the threshold DC voltage value into a data storage circuit.

Embodiments of the present disclosure provide apparatus for regulating power provided to a remote network component. Some embodiments of such apparatus include a monitoring circuit configured to estimate a DC input voltage that is received from a central network power supply and a control circuit that is configured to compare the DC input voltage to a threshold DC voltage value to determine if the DC input voltage exceeds the threshold DC voltage value. Some embodiments may also include a voltage conversion circuit that, if the DC input voltage exceeds the threshold DC voltage value, is configured to convert the DC input voltage to a DC output voltage at an output voltage conductor that is less than the threshold DC voltage value and a bypass circuit that, if the DC input voltage is less than the threshold DC voltage value, is configured to bypass the voltage conversion circuit and transmit the DC input voltage to the remote network device via the output voltage conductor as the DC output voltage.

In some embodiments, the bypass circuit includes at least one field effect transistor that is configured to selectively conduct the DC input voltage to the output voltage conductor. In some embodiments, the bypass circuit includes at least one relay that is configured to selectively conduct the DC input voltage to the output voltage conductor. Some embodiments may include a data storage circuit that is configured to receive and store at least the threshold DC voltage value.

Some embodiments may include a transition circuit that is configured to provide a smooth transition of the DC output voltage when the bypass circuit is activated and de-activated. In some embodiments, the transition circuit includes a capacitive load coupled to the output voltage connector. Some embodiments may include means for estimating a plurality of threshold DC voltage values using a hysteresis function to reduce oscillation between the voltage conversion circuit and the bypass circuit.

Embodiments of the present disclosure provide methods for providing compliant power for a remote device. Embodiments of such methods may include selectively regulating a DC input voltage and providing a DC output voltage to the remote device responsive to a dynamic input voltage. In some embodiments, selectively regulating includes comparing the DC input voltage to a threshold DC voltage value. In some embodiments, selectively regulating further includes transmitting the DC input voltage as the DC output voltage if the DC input voltage is less than the threshold DC voltage value.

In some embodiments, selectively regulating also includes converting the DC input voltage to the DC output voltage that is less than the threshold DC voltage value if the DC input voltage is greater than the threshold DC voltage value. Some embodiments include filtering the DC output voltage to dampen transitions in the DC output voltage. Some embodiments include transitioning the DC output voltage via multiple incremental changes.

Other apparatus and methods according to embodiments of the disclosure will be or become apparent to one with skill in the art upon review of the following drawings and detailed description. It is intended that all such additional apparatus and methods be included within this description, be within the scope of the present disclosure, and be protected by the accompanying claims.

### BRIEF DESCRIPTION OF THE DRAWINGS

FIG. 1 is a block diagram illustrating a conventional broadband communications system.

FIGS. 2A and 2B are plots of received voltage illustrating dynamic effects of varying loads and conductor distances, respectively, in a system configured to provide power to remote devices from a central power source according to some embodiments disclosed herein.

FIG. 3 is a block diagram illustrating a broadband communications system utilizing methods and/or apparatus according to some embodiments disclosed herein.

FIG. 4 is a block diagram illustrating an apparatus for regulating power provided to a remote device according to some embodiments disclosed herein.

FIG. 5 is a flow diagram illustrating operations for providing power to remote devices according to some embodiments disclosed herein.

FIG. 6 is a flow diagram illustrating operations for providing power to a remote network device according to some embodiments disclosed herein.

FIG. 7 is a flow diagram illustrating operations for providing compliant power to a remote device according to some embodiments disclosed herein.

FIG. 8 is a flow diagram illustrating operations for providing compliant power to a remote device according to some further embodiments disclosed herein.

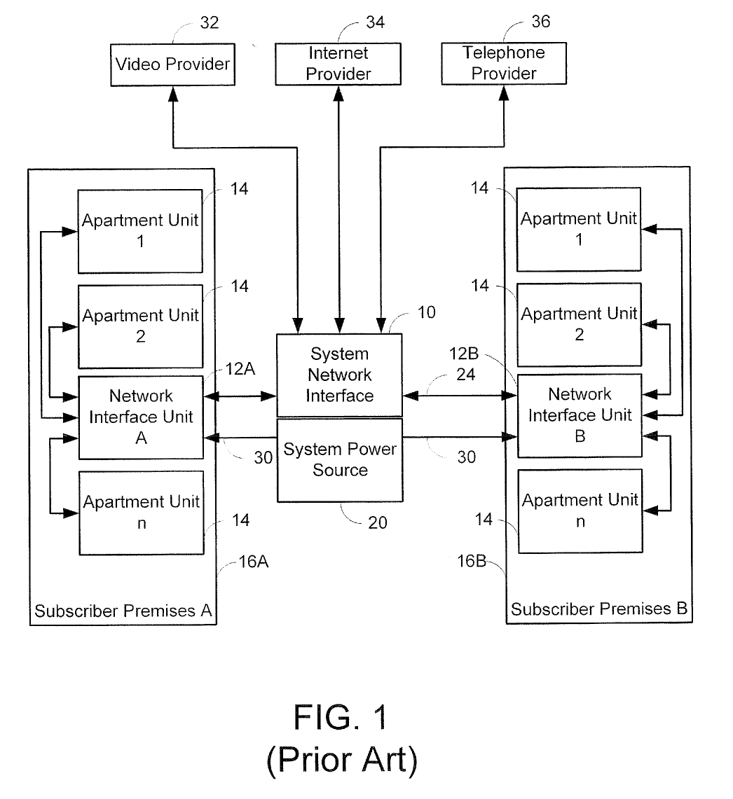

### DETAILED DESCRIPTION

The present disclosure now will be described more fully hereinafter with reference to the accompanying figures, in which embodiments of the disclosure are shown. This disclosure may, however, be embodied in many alternate forms and should not be construed as limited to the embodiments set forth herein.

Accordingly, while the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure as defined by the claims. Like numbers refer to like elements throughout the description of the figures.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements and/or components, but do not preclude the presence or addition of one or more other features, integers, steps, operations, elements, components, and/or groups thereof. Moreover, when an element is referred to as being “responsive” to another element, it can be directly responsive to the other element, or intervening elements may be present. In contrast, when an element is referred to as being “directly responsive” to another element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another.

The present disclosure is described below with reference to block diagrams and/or flowchart illustrations of methods, apparatus (systems and/or devices) and/or computer program products according to embodiments of the disclosure. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present disclosure may be embodied in hardware and/or in software (including firmware, resident software, micro-code, etc.). Furthermore, the present disclosure may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

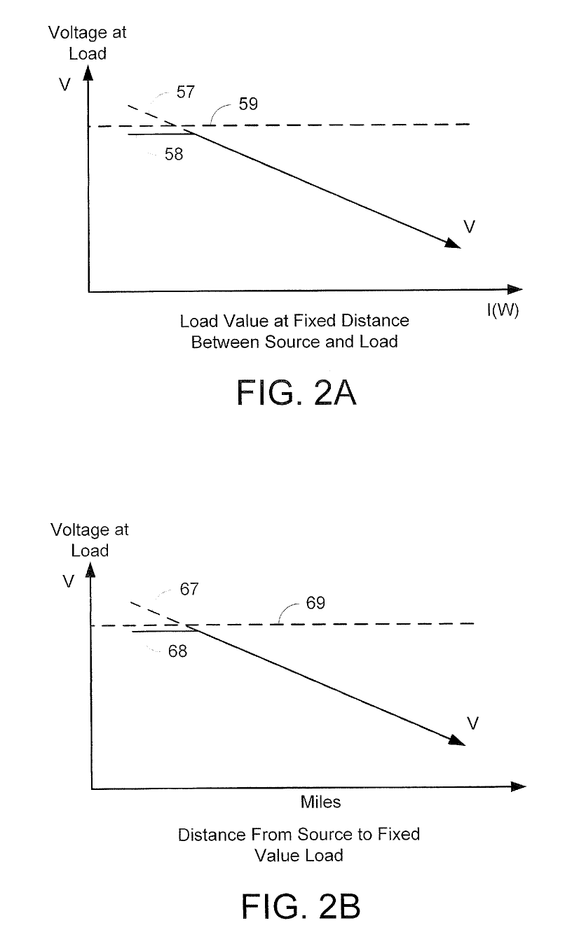

Some embodiments of the present disclosure may arise from recognition that it may be desirable to provide power to remote devices from a central power source by providing selective regulation of received power at such remote devices. In particular, regulation may be responsive to varying levels of received direct current (DC) voltages in view of operational limitations. For example, FIGS. 2A and 2B are plots of received voltage illustrating dynamic effects of varying loads and conductor distances, respectively, in a system configured to provide power to remote devices from a central power source.

Reference is now made to FIG. 2A, which is a plot of the received voltage as a function of the load value. The load value may be expressed in terms of current and/or power for any given source voltage. As the load value increases, the received voltage 58 decreases by virtue of a voltage drop corresponding to the product of the current and the resistance of the conductive line between the remote device and the central power source, as defined by Ohm's law. In this regard, to ensure that an adequate minimum received voltage 58 is provided to the remote device, the central power source voltage may be established sufficiently high to address maximum load conditions.

A maximum voltage that may be provided to a remote device may be defined and/or restricted. Such restrictions may arise through design and/or functional limitations within a remote device and/or via rules and/or codes as might be promulgated by a regulatory agency and/or document, such as, for example, the National Electric Code (NEC), among others. Thus, a threshold voltage 59 may be determined as a function of a maximum delivered voltage to the remote device. In this regard and as illustrated, the received voltage 58 may be limited to levels below the threshold voltage 59 via the methods and/or apparatus described herein. Absent application of the methods and/or apparatus described herein, the received voltage might otherwise exceed the threshold voltage 59 as illustrated by unregulated received voltage 57.

In addition to remote devices that may operate at different and varied load levels, the distances from the central power source to different remote devices may vary. The voltage received at a remote device may be affected similarly by the different line resistances associated with the different distances. For example, the voltages received over lines of different lengths may be different corresponding to the different line resistances. In this regard, reference is now made to FIG. 2B, which is a plot of the received voltage as a function of distance 66 between a remote device and a central power source.

As the distance between the central power source and a remote device increases, the received voltage 68 decreases. In this regard, to ensure that an adequate minimum received voltage 68 is provided to the remote devices that are farthest from the central power supply, the central power source voltage should be sufficiently high to address the maximum distance.

As discussed above regarding FIG. 2A, a maximum voltage that may be provided to a remote device may be defined and/or restricted. Thus, a threshold voltage 69 may be determined as a function of a maximum delivered voltage to a remote device. In this regard, the received voltage 68 may be limited to levels below the threshold voltage 69 via the methods and/or apparatus described herein. Absent application of the methods and/or apparatus described herein, the received voltage might otherwise exceed the threshold voltage 69 as illustrated by unregulated received voltage 67. In addition to providing a central power supply voltage that is sufficiently high to address distal remote devices operating under maximum load conditions, it may be desirable to increase the central power supply voltage to improve efficiency by reducing resistive line losses via reduced current requirements. Thus, a central power supply configured to provide power to multiple remote devices at different distances and configured to operate under varied load conditions may be operated at a voltage that exceeds requisite and/or suggested threshold voltages.

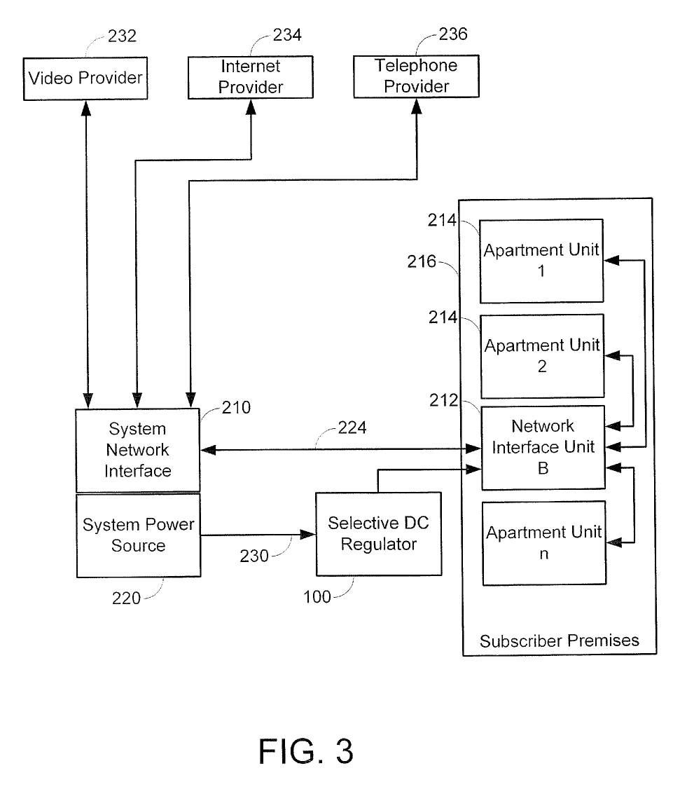

Reference is now made to FIG. 3, which is a block diagram illustrating a broadband communications system utilizing methods and apparatus according to some embodiments described herein. A system network interface 210 may provide, via data communication media 224, network services to a network interface unit 212 located at subscriber premises 216. Exemplary network services may include those provided by a video provider 232, an Internet provider 234, and/or a telephone provider 236, among others.

A remotely located network interface unit 212 may be powered from a centrally located system power source 220 via a premises located selective DC regulator 100. Power may be provided as a direct current (DC) supply voltage provided at the system power source 220 and transmitted via power conductors 230 to the selective DC regulator 100, which provides selectively regulated DC power to the network interface unit 212. Although illustrated as distinct components, in some embodiments, the power conductors 230 and the data communication media 224 may be provided in a composite cable. In some embodiments, the power conductors 230 and the data communication media 224 may be implemented in the same conductor(s). The load requirement corresponding to the subscriber premises 216 is dynamic and may vary based on a variety of factors including, for example, quantity and types of services provided by the network interface unit 212 and the instantaneous state of subscriber line.

As discussed above regarding FIGS. 2A and 2B, the system power source 220 may provide voltage sufficient to power a network interface unit 212 deployed at a maximum design distance under maximum load conditions. However, since the network interface unit 212 may be limited to a maximum received voltage, the selective DC regulator 100 may be configured to reduce received DC voltage that exceeds a voltage threshold to an acceptable voltage level. The selective DC regulator 100 may be further configured to bypass the DC voltage reduction circuit if the received voltage is less than the threshold voltage.

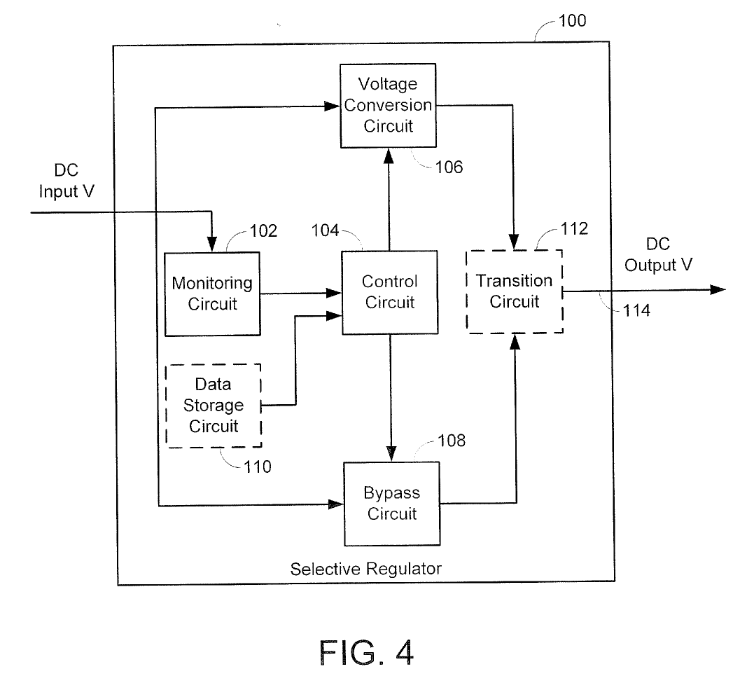

Reference is now made to FIG. 4, which is a block diagram illustrating an apparatus for regulating power provided to a remote device according to some embodiments described herein. The selective DC regulator 100 is configured to receive a DC input voltage from a central power source. The DC input voltage may be monitored by a monitoring circuit 102 that is configured to estimate a DC input voltage received from the central power source. In some embodiments, the central power source can include a central network power supply, among others. The selective DC regulator 100 may include a control circuit 104 that is configured to compare the DC input voltage to a threshold DC voltage value to determine if the DC input voltage exceeds the threshold DC voltage value. In some embodiments, the selective DC regulator 100 may include a data storage circuit 110 that is configured to receive and store the threshold DC voltage value, among others. In this regard, a control circuit 104 may be configured to receive the threshold DC voltage value from the optional data storage circuit 110.

Some embodiments include determining the threshold DC voltage value as a function of a regulatory agency installation code requirement. For example, Article 830 of the National Electric Code (NEC) provides that the voltage presented to network interface units located on subscriber premises should be less than 150 VDC. Thus, to ensure compliance with this portion of the NEC, the threshold DC voltage value may be established as some value less than 150 VDC.

If the control circuit 104 determines that the DC input voltage exceeds the threshold DC voltage value, then a voltage conversion circuit 106 may convert the DC input voltage to a DC output voltage that is less than the threshold DC voltage value. The DC output voltage may be provided to an output voltage conductor 114 for receipt by a remote device. In some embodiments, the output voltage conductor 114 may be configured as an output terminal to which a transmission conductor may be conductively coupled. A remote device may include, for example, a network interface unit, among others. In some embodiments, other remote devices may include, for example, a variety of devices that may benefit from selectively regulated DC voltage, such as remotely located rechargeable batteries and/or battery charging circuits.

If the control circuit 104 determines that the DC input voltage is below the threshold DC voltage value, then a bypass circuit 108 may be used to transmit the DC input voltage to the output voltage conductor 114 as a DC output voltage. In some embodiments, the bypass circuit 108 may include one or more field effect transistors that are configured to selectively transmit the DC input voltage to the output voltage conductor 114. In some embodiments, the bypass circuit 108 may include one or more relays that are configured to selectively transmit the DC input voltage to the output voltage conductor 114.

In some embodiments, transition circuit 112 may be used to provide a smooth transition of the DC output voltage when the bypass circuit is activated and deactivated. In some embodiments, the transition circuit 112 may include a capacitive load coupled to the output voltage conductor 114. In some embodiments, the transition circuit 112 is configured to transition the DC output voltage via multiple incremental changes. The circuits described herein may include analog and/or digital components including, but not limited to microprocessors, among others.

Some embodiments may include means for estimating multiple threshold DC voltage values using, for example, a hysteresis function, which may reduce oscillation between the voltage conversion circuit and the bypass circuit when the DC input voltage fluctuates within a range that includes the threshold DC voltage value. In some embodiments, a control deadband, which is an area of a signal range or band where no action occurs, may provide for a first threshold DC voltage value for converting from the voltage conversion circuit to the bypass circuit and a second threshold DC voltage value for converting from the bypass circuit to the voltage conversion circuit. In some embodiments, the first threshold DC voltage value may be less than the second threshold DC voltage value. In some embodiments, control induced oscillations may be reduced via a timer function that is configured to provide an instantaneous transition from a bypass state to a conversion state and a time delayed transition from a conversion state to a bypass state.

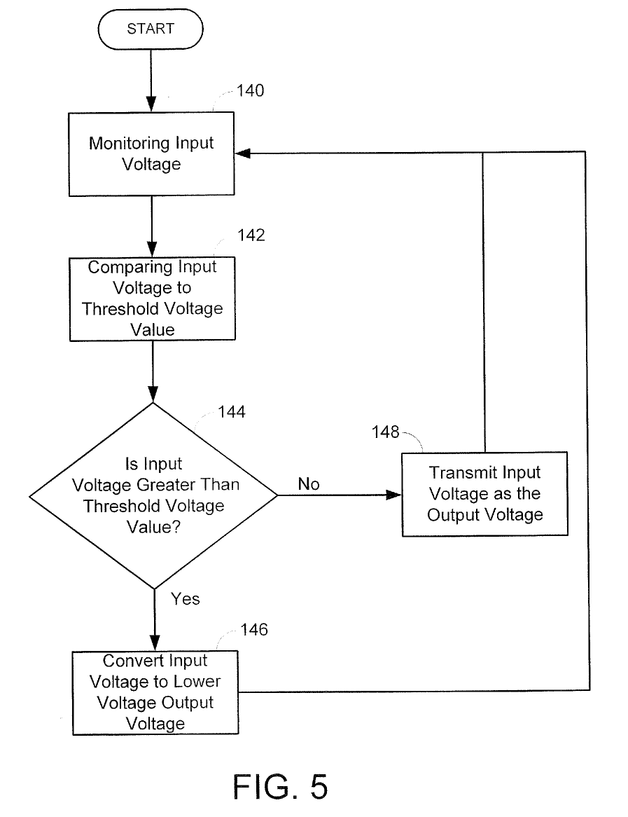

Reference is now made to FIG. 5, which is a flow diagram illustrating operations for providing power to remote devices according to some embodiments described herein. In some embodiments, operations begin with monitoring an input voltage (block 140). For example, a monitoring circuit may include a potential transformer (PT) and/or an analog-to-digital converter (A/D) may be used to monitor the input voltage. The input voltage may be a voltage received from a power source such as, for example, a central power supply. Although described in some embodiments herein as a DC voltage, in some embodiments, the input voltage may be an alternating current (AC) voltage.

The input voltage is compared to a threshold voltage value (block 142). The comparison may be performed using an analog comparator and/or a digital data processing device. The threshold voltage value may be a previously determined voltage value that corresponds to a maximum voltage for a remote device. The threshold voltage value may be stored in processor memory, system memory, a register, and/or as an analog value, among others.

Whether the input voltage is greater than the threshold voltage value is determined (block 144). If the input voltage is greater than the threshold voltage value, then the input voltage is converted to an output voltage that is lower than the threshold voltage value (block 146). Conversion of the input voltage to an output voltage that is lower than the threshold voltage may be performed by a DC to DC converter, a rectifier, an inverter and/or an AC transformer, depending on the forms of the input and output voltages. The output voltage may then be transmitted to the remote device. After the voltage is converted and/or the conversion circuit is bypassed, the input voltage may be continuously and/or periodically monitored (block 140).

If the input voltage is not greater than the threshold voltage value, then the input voltage is transmitted to the remote device as the output voltage (block 148). Transmission of the input voltage as the output voltage may effectively bypass the conversion function. Bypassing the conversion function may be accomplished via a relay, a switch, and/or a power semiconductor such as a power FET, among others. In this manner, the input voltage may be selectively regulated responsive to a comparison of the input voltage and a threshold voltage value. By selectively regulating the input voltage, inefficiencies corresponding to a voltage conversion circuit may be avoided except when conditions result in an input voltage value that exceeds the threshold voltage value.

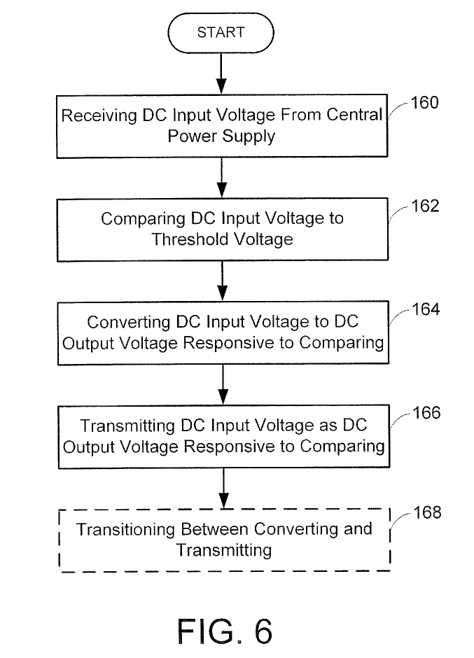

Reference is now made to FIG. 6, which is a flow diagram illustrating operations for providing power to a remote network device according to some embodiments disclosed herein. Operations begin with receiving, at the remote network device location, a DC input voltage from a central network power supply (block 160). The DC input voltage is compared to a threshold DC voltage value to determine if the received DC input voltage exceeds the threshold DC voltage value (block 162). In some embodiments, the comparison is performed using one or more data processing components including, but not limited to, a microprocessor, a programmable field gate array, and/or an analog circuit.

The threshold DC voltage value may be determined as a function of, for example, a maximum permitted received voltage at the remote network device. In some embodiments, the threshold DC voltage value may be stored in a data storage circuit. A data storage circuit may include analog and/or digital components and may be configured to receive and/or store initial and/or updated threshold DC voltage values.

If the DC input voltage exceeds the threshold DC voltage value, the DC input voltage can be converted into a DC output voltage that is below the threshold DC voltage value (block 164). In this manner, the DC output voltage provided to the remote network device may be less than the threshold DC voltage value regardless of the value of the DC input voltage. Conversion of the DC input voltage to the DC output voltage may be performed using, for example, a DC-DC converter that may be selectively used.

If the DC input voltage is below the threshold DC voltage value, the DC input voltage may be transmitted as the DC output voltage (block 166). Transmitting the DC input voltage as the DC output voltage may effectively bypass the voltage conversion operation and thus may reduce operational inefficiencies associated with a voltage conversion operation. Additionally, the remote network device may receive the maximum available voltage up to the threshold DC voltage value. Some embodiments may optionally include transitioning from converting the DC input voltage to transmitting the DC input voltage and from transmitting the DC input voltage to converting the DC input voltage (block 168). In some embodiments, transitioning may include filtering the DC output voltage to dampen a transition from converting the DC input voltage to transmitting the DC input voltage. In some embodiments, filtering may include providing capacitance at an output terminal corresponding to the DC output voltage.

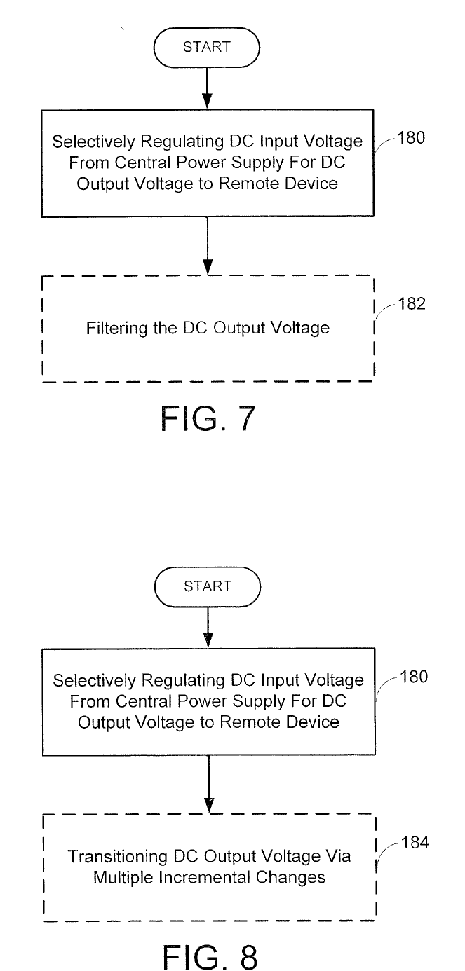

Reference is now made to FIGS. 7 and 8, which are flow diagrams illustrating operations for providing compliant power to a remote device according to some embodiments disclosed herein. Operations may include selectively regulating a DC input voltage to provide a DC output voltage to the remote device responsive to a DC input voltage from a central power supply (block 180). In some embodiments, selectively regulating a DC input voltage may include comparing the DC input voltage to a threshold DC voltage value. In some embodiments, selectively regulating may further include transmitting the DC input voltage as the DC output voltage if the DC input voltage is less than the threshold DC voltage value. Some embodiments provide that selectively regulating includes converting the DC input voltage to the DC output voltage that is less than the threshold DC voltage value if the DC input voltage is greater than the threshold DC voltage value.

Some embodiments may include filtering the DC output voltage to dampen transitions therein (block 182). For example filtering the DC output voltage may include adding capacitance across output terminals and/or conductors corresponding to the DC output voltage. Referring to FIG. 8, some embodiments may optionally include transitioning the DC output voltage via multiple incremental changes (block 184). By using multiple incremental changes, abrupt and/or oscillating changes in the DC output voltage associated with switching between converting the DC input voltage and bypassing the conversion circuit may be reduced.

In the drawings and specification, there have been disclosed embodiments of the disclosure and, although specific terms are employed, they are used in a generic and descriptive sense only and not for purposes of limitation, the scope of the disclosure being set forth in the following claims.

What is claimed is:

1. A method of providing power to a remote network device, comprising:
receiving a DC input voltage;
comparing the DC input voltage to a threshold DC voltage value to determine if the received DC input voltage exceeds the threshold DC voltage value;
converting the DC input voltage into a DC output voltage that is below the threshold DC voltage value if the DC input voltage exceeds the threshold DC voltage value; and
transmitting the DC input voltage to the remote network device as the DC output voltage if the DC input voltage is less than the threshold DC voltage value.

2. The method of claim 1, further comprising transitioning from converting the DC input voltage to transmitting the DC input voltage and from transmitting the DC input voltage to converting the DC input voltage.

3. The method of claim 2, wherein transitioning comprises filtering the DC output voltage to dampen a transition from the converting the DC input voltage to the transmitting the DC input voltage.

4. The method of claim 3, wherein filtering comprises providing capacitance at an output terminal corresponding to the DC output voltage.

5. The method of claim 1, further comprising:
determining the threshold DC voltage value based on a regulatory agency installation code requirement; and
receiving the threshold DC voltage value into a data storage circuit.

6. An apparatus for regulating power provided to a remote network component, the apparatus comprising:
a monitoring circuit configured to estimate a DC input voltage that is received from a central network power supply;
a control circuit that is configured to compare the DC input voltage to a threshold DC voltage value to determine if the DC input voltage exceeds the threshold DC voltage value;
a voltage conversion circuit that, if the DC input voltage exceeds the threshold DC voltage value, is configured to convert the DC input voltage to a DC output voltage at an output voltage conductor that is less than the threshold DC voltage value; and
a bypass circuit that, if the DC input voltage is less than the threshold DC voltage value, is configured to bypass the voltage conversion circuit and transmit the DC input voltage to the remote network device via the output voltage conductor as the DC output voltage.

7. The apparatus of claim 6, wherein the bypass circuit comprises at least one field effect transistor that is configured to selectively conduct the DC input voltage to the output voltage conductor.

8. The apparatus of claim 6, wherein the bypass circuit comprises at least one relay that is configured to selectively conduct the DC input voltage to the output voltage conductor.

9. The apparatus of claim 6, further comprising a data storage circuit that is configured to receive and store at least the threshold DC voltage value.

10. The apparatus of claim 6, further comprising a transition circuit that is configured to provide a smooth transition of the DC output voltage when the bypass circuit is activated and de-activated.

11. The apparatus of claim 10, wherein the transition circuit comprises a capacitive load coupled to the output voltage conductor.

12. The apparatus of claim 6, further comprising means for estimating a plurality of threshold DC voltage values using a hysteresis function to reduce oscillation between the voltage conversion circuit and the bypass circuit.

13. A method of providing compliant power to a remote device, comprising:
selectively regulating a DC input voltage; and
providing a DC output voltage to the remote device responsive to a dynamic input voltage.

14. The method of claim 13, wherein selectively regulating comprises comparing the DC input voltage to a threshold DC voltage value.

15. The method of claim 14, wherein selectively regulating further comprises transmitting the DC input voltage as the DC output voltage if the DC input voltage is less than the threshold DC voltage value.

16. The method of claim 14, wherein selectively regulating further comprises converting the DC input voltage to the DC output voltage that is less than the threshold DC voltage value if the DC input voltage is greater than the threshold DC voltage value.

17. The method of claim 13, further comprising filtering the DC output voltage to dampen transitions in the DC output voltage.

18. The method of claim 13, further comprising transitioning the DC output voltage via a plurality of incremental changes.
